(19) United States
(12) Patent Application Publication
(10) Pub. No.: US 2026/0093134 A1
(43) Pub. Date: Apr. 2, 2026

(54) OPTICAL DEVICE CAPABLE OF CAUSING A NON-VOLATILE PHASE SHIFT IN OPTICAL SIGNAL

(71) Applicant: HEWLETT PACKARD ENTERPRISE DEVELOPMENT LP, Spring, TX (US)

(72) Inventors: Yingtao Hu, Santa Barbara, CA (US); Stanley Cheung, Milpitas, CA (US)

(21) Appl. No.: 18/899,059

(22) Filed: Sep. 27, 2024

(51) Int. Cl. G02F 1/035; G02F 1/03

(52) U.S. Cl. CPC G02F 1/035; G02F 1/0316

(57) ABSTRACT

Examples described herein relate to an optical device for phase shifting an optical signal. The optical device includes an optical waveguide, a ferroelectric material layer formed over the optical waveguide, a transition material layer made of a transparent conductive material disposed in electrical contact with the ferroelectric material layer, and a pair of electrodes comprising a first electrode in electrical contact with the transition material layer and a second electrode in electrical contact with the optical waveguide. The above referenced layers are arranged such that the ferroelectric material layer and the transition material layer are stacked vertically over the optical waveguide. Under an application of an operating voltage across the pair of electrodes, a vertical electric field may be applied across the ferroelectric material layer.

### BACKGROUND

Phase shifters are generally used in photonic integrated circuits to control the phase of an optical signal. For example, phase shifters are widely used in many optical devices, such as optical modulators and optical Mach Zehnder interferometers (MZIs). Generally, optical phase shifters based on silicon photonics are designed to induce a phase shift in an optical signal using a plasma dispersion effect. The plasma dispersion effect is an electro-optic effect in which charge carrier concentrations in a silicon waveguide may be altered to cause a change in the refractive index of the silicon waveguide, which in turn introduces a phase shift into an optical signal propagating through the silicon waveguide. Common optical phase shifters used in photonic integrated circuits are a PN junction, a PIN junction, and a metal-oxide-semiconductor capacitor (MOSCAP). Also, the placement of ferroelectric materials in proximity to an optical waveguide is found to cause a phase shift in the optical signal.

### BRIEF DESCRIPTION OF THE DRAWINGS

Various examples will be described below with references to the following figures.

FIG. 1 depicts a cross-sectional view of an example optical device.

FIG. 2 depicts a cross-sectional view of another example optical device.

FIG. 3 depicts a cross-sectional view of another example optical device.

FIG. 4 depicts a cross-sectional view of another example optical device.

FIG. 5 depicts a cross-sectional view of another example optical device.

FIG. 6 depicts a cross-sectional view of yet another example optical device.

FIGS. 7A and 7B depict graphical representations comparing the electric field strengths of a conventional optical device and the example optical device of FIG. 2.

FIG. 8 depicts another graphical representation comparing the electric field strengths of a conventional optical device and the example optical device of FIG. 2.

FIG. 9 depicts a block diagram of an example computing system hosting an example optical device.

It is emphasized that, in the drawings, various features are not drawn to scale. In fact, in the drawings, the dimensions of the various features have been arbitrarily increased or reduced for clarity of discussion.

### DETAILED DESCRIPTION

The following detailed description refers to the accompanying drawings. Wherever possible, the same reference numbers are used in the drawings and the following description to refer to the same or similar parts. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

Optical systems include optical devices that can generate, process, and/or carry optical signals from one point to another point. In certain implementations, optical systems such as optical communication systems may facilitate data communication over longer distances with higher bandwidth using smaller cable width (or diameter) in comparison to communication systems using electrical wires. In an optical communication system, an optical signal (i.e., light) may be generated by a light source such as a laser. The optical signal may then be modulated, and such modulated optical signal may be transmitted to an optoelectronic receiver through an optical fiber. The optoelectronic receiver may demodulate the received signal.

Optical components, for example, an optical modulator may use a phase shifter to phase shift an optical signal and to achieve a desired modulation. In the phase shifters implemented via silicon photonics, a well-known plasma dispersion effect is commonly used which entails altering carrier concentrations in a silicon waveguide to induce phase shift in the optical signal. The most common optical phase shifters that use the plasma dispersion effect are a carrier depletion mode PN junction, a carrier injection mode PIN junction, and a carrier accumulation mode Metal Oxide Semiconductor Capacitor (MOSCAP). In the abovementioned phase shifters, the free carrier densities in the respective regions may be controlled by applying electrical voltage to the respective phase shifters causing a phase shift in the optical signal passing through an optical waveguide.

Alternative to the phase shifters that use the plasma dispersion effect, other types of phase shifters that use ferroelectric materials are also commonly used to induce non-volatile phase shift. In particular, programmable integrated photonic circuits are becoming increasingly complex in supporting applications such as optical computing, optical neural networks, optical quantum computing, optical sensing, and multipurpose photonic signal processing. In such programmable integrated photonic circuits, non-volatile phase shifting is a key operation to enable several complex features and applications. In particular, a non-volatile optical phase shifter is a key building block for efficient reconfigurable programmable integrated photonic circuits.

Commonly known optical phase shifters used for non-volatile phase shifting generally entail using microelectromechanical systems (MEMS) and waveguides enhanced with phase-change materials (PCMs). These technologies face difficulties in providing multiple states of operation, and in particular, the PCMs introduce optical loss during phase shifting, making the devices using these technologies unsuitable for programming coherent photonic networks where adjustments to the optical phase alone are required. Compared to using MEMS and PCMs, ferroelectric materials present a promising solution as non-volatile phase shift materials, offering pure phase shifts without changing the amplitude of the optical signal. In particular, a ferroelectric material such as BaTiO3 (BTO) is promising for such phase shifters.

Conventional device structures of the optical phase shifters that use ferroelectric materials generally include a ferroelectric material layer disposed near an optical waveguide, and metal electrodes placed on the ferroelectric material layer. In certain other known device structures that include ferroelectric materials, the metal electrodes are placed laterally away from the optical waveguide and encapsulated in an oxide layer adjacent to the optical waveguide. In such conventional device structures, the application of electricity to the metal electrodes may exert a lateral electric field (i.e., the electric field is oriented along a lateral direction of the optical phase shifters) to the ferroelectric material layer. The lateral electric field across the ferroelectric material layer causes a change in the phase of a guided optical mode of the optical signal propagating via the optical waveguide. The lateral electric field is generally weak in inducing a desired phase change in the optical mode. In particular, in conventional device structures, the metal electrodes are placed at a distance from the optical waveguide to reduce optical losses. The increased distance between the metal electrodes requires a relatively high operating voltage to switch the ferroelectric domain and achieve the desired phase shift. This results in inefficient phase shifting of the optical signal.

In accordance with the examples presented herein, an optical device (e.g., an optical phase shifter) capable of providing a non-volatile optical phase shift to an optical signal is presented. In particular, the proposed optical device has a hybrid photonic structure comprising a ferroelectric material layer compactly integrated with an optical waveguide to overlap with the optical mode. The optical mode is an electric field distribution of an optical signal passing through the optical waveguide. The ferroelectric material layer may include a single layer of ferroelectric material or multiple thin films of the ferroelectric material formed over the optical waveguide. Further, the proposed optical device includes a transition material layer comprising a transparent conductive material disposed over the ferroelectric material layer.

Furthermore, the proposed optical device includes a pair of electrodes comprising a first electrode in electrical contact with the optical waveguide and a second electrode in electrical contact with the transition material layer. The term “electrical contact” as used herein may refer to a direct physical contact between two material layers or a contact between the two material layers via one or more intermediate electrically conductive materials such that electricity can flow through both the material layers when a potential difference (e.g., a non-zero voltage) is applied across the two material layers.

As will be appreciated, the proposed optical device having the hybrid photonic structure noted hereinabove allows for the application of a vertical electric field (e.g., an electric field that is oriented along a vertical direction of the optical device) to the ferroelectric material layer. Due to the presence of the transition material layer, electrodes can be positioned close to the bottom or top of the ferroelectric layer. Further, as the ferroelectric material layer is sandwiched between the transition material layer and the optical waveguide with a large surface contact area (e.g., in one example implementation, the top and bottom surfaces of the ferroelectric material layer may fully contact respectively with the transition material layer and the optical waveguide), a much stronger electric field may be created with similar applied voltages compared to conventional devices while minimizing optical losses to the optical mode.

Moreover, the vertical device structure of the proposed optical device allows for the incorporation of multiple ferroelectric layers, enhancing the electro-optical effect. Moreover, electronic simulations performed for the proposed optical device indicate that the proposed optical device can significantly improve the performance of the non-volatile phase shifter, i.e., impart a greater amount of phase shift for a given unit voltage relative to the conventional optical phase shifters. Additionally, ferroelectric materials like hafnium zirconium oxide can be easily deposited using Complementary Metal-Oxide-Semiconductor (CMOS) compatible processes, making the proposed hybrid photonic structures highly suitable for large-scale CMOS-compatible manufacturing.

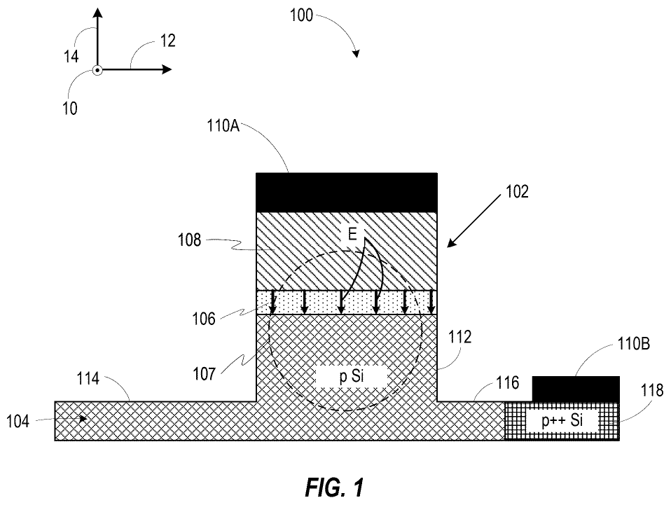

In the description hereinafter, example optical devices are described with the help of several cross-sectional views oriented per axial, lateral, and vertical directions marked in the respective Figures. The axial, lateral, and vertical directions are perpendicular to each other. For ease of illustration and consistency, the axial, lateral, and vertical directions in all cross-sectional views (e.g., in FIGS. 1-6) are marked using the same reference numerals. Further, the measurements that may be taken along the axial, lateral, and vertical are referred to as length, width, and height, respectively.

FIG. 1 depicts a cross-sectional view 100 of an example optical device 102. Further, in all Figures, including FIGS. 1-6, depicting respective cross-sectional views, the arrows marked with reference numerals 10, 12, and 14 respectively represent axial, lateral, and vertical directions. The optical device 102 of FIG. 1 may be an optical phase-shifter useful for phase shifting an optical signal. For example, the optical device 102 may be an optical modulator, such as a ring modulator or a linear modulator. In another example, the optical device 102 may be a Mach-Zehnder Interferometer (MZI). In some examples, the optical device 102 may form a part of a photonic integrated circuit. In one example implementation, the photonic integrated circuit may be implemented in an optical transceiver. The optical transceiver, in some examples, is disposed in an electronic system such as but not limited to, computers (stationary or portable), servers, storage systems, wireless access points, network switches, routers, docking stations, printers, or scanners.

The optical device 102 may include an optical waveguide 104, a ferroelectric material layer 106, a transition material layer 108, and a pair of electrodes 110A and 110B. During the operation of the optical device 102, an optical waveguide 104 may allow an optical signal to propagate therethrough, and operating voltage may be applied across the electrodes 110A and 110B to induce a non-volatile phase shift in the optical signal passing through the optical waveguide 104. In particular, in the example implementation of FIG. 1, the ferroelectric material layer 106 is formed over the optical waveguide 104, and the transition material layer 108 is disposed in electrical contact with the ferroelectric material layer 106 such that the ferroelectric material layer 106 and the transition material layer 108 are stacked vertically over the optical waveguide 104. As will be described in greater detail later in the description, the presence of the transition material layer 108 provides a separation between an optical mode (marked using dashed circle 107, hereinafter referred to as optical mode 107) and the electrode 110A, blocking the light absorption via the electrode 110A, thereby reducing the optical losses. Further, the amount of phase shift caused in the optical signal may be proportional to the magnitude of the operating voltage applied across the electrodes 110A and 110B.

The optical waveguide 104 may be formed using a semiconductor material, such as but not limited to, silicon (Si), one or more types of silicon nitrides (SiN) with variable ratios of Si and Nitrogen (e.g., Si₃N₄), indium phosphide (InP), gallium arsenide (GaAs), silicon carbide (SiC), aluminum gallium arsenide (AlGaAs), indium gallium arsenide (InGaAs), silicon dioxide (SiO₂), Lithium Niobate (LiNbO₃), Gallium Nitride (GaN), Polymer, or combinations thereof. For illustration purposes, in FIGS. 1-5, the optical waveguide 104 is described as formed using silicon. The optical waveguide 104 may be formed in a variety of shapes. For example, the optical waveguide 104 may have a linear shape, a non-linear shape, or an annular shape, such as a ring shape or a loop shape (e.g., circular loop, oval loop, rounded rectangle loop, rounded square loop, rounded triangle loop, etc.). In some examples, the optical waveguide 104 may have an elongated loop shape (e.g., a racetrack shape). Further, as seen in the cross-sectional view 100 of FIG. 1, the optical waveguide 104 may include a waveguide core 112 and waveguide arms 114 and 116. The waveguide core 112 is a region of the optical waveguide 104 in which the optical mode 107 of the optical signal whereas, one or more of the waveguide arms 114 and 116 arms may be used to provide electrical connectivity to the optical waveguide 104.

Further, in some examples, the optical waveguide 104 may include suitable doping, such as p-type doping or n-type doping. For illustration purposes, in FIG. 1, the optical waveguide 104 is shown to include p-type doping. Such doping may be achieved by introducing a suitable type of impurity into the semiconductor material of the optical waveguide 104 using techniques such as impurity diffusion, ion implantation, in-situ doping, and the like. For example, n-type doping may be achieved by doping a respective semiconductor material with impurities having donor ions including, but not limited to, phosphorus (P), arsenic (As), antimony (Sb), or bismuth (Bi). Accordingly, a semiconductor material with n-type doping may have electrons in excess of holes. In semiconductor materials with n-type doping, the electrons that are in excess of the holes are also referred to as free electrons. Accordingly, with n-type doping, the free electrons act as free charge carriers.

Furthermore, p-type doping may be achieved by doping a respective semiconductor material with impurities having acceptor ions including, but not limited to, boron (B), gallium (Ga), indium (In), or aluminum (Al). Accordingly, the semiconductor material with p-type doping may have holes in excess of electrons. In semiconductor materials with p-type doping, the holes that are in excess of the electrons are also referred to as free holes which act as free charge carriers. In the description hereinafter, the term “free charge carriers” or “free carriers” may represent the free electrons with reference to the semiconductor material when having n-type doping. Further, the term “free charge carriers” or “free carriers” may represent the free holes with reference to the semiconductor material when having p-type doping.

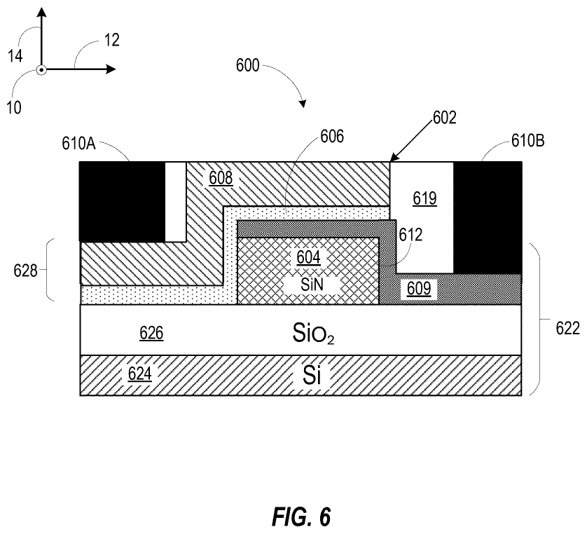

Moreover, in the device structure of the optical device 102, the ferroelectric material layer 106 is formed over the optical waveguide 104. In one example, as depicted in FIG. 1, the ferroelectric material layer 106 may laterally overlap with the top surface of the waveguide core 112 and is formed in direct physical contact with the top surface of the waveguide core 112. In certain other examples, one or more additional intermediate layers may be formed between the ferroelectric material layer 106 and the waveguide core 112 (see FIG. 6, for example).

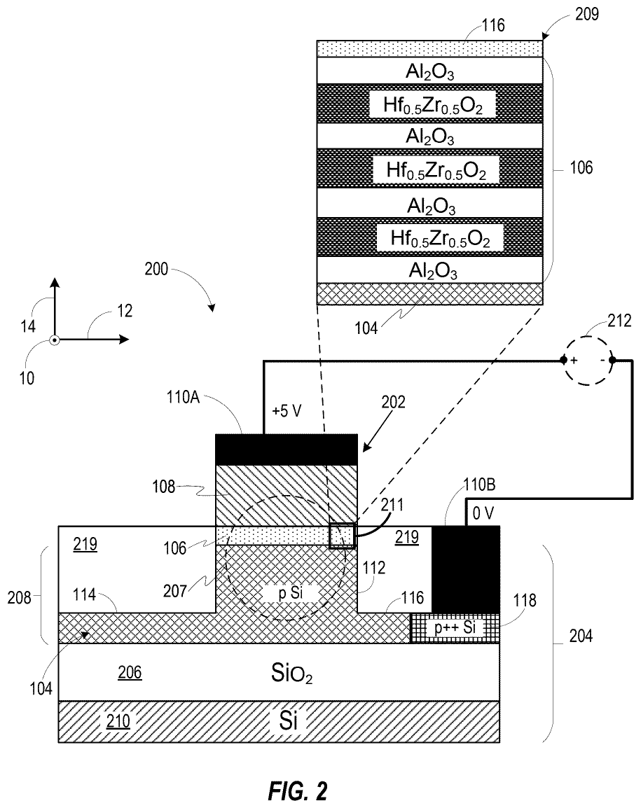

The ferroelectric materials used to form the ferroelectric material layer 106 may be dielectric materials that exhibit a non-linear dielectric constant variation with an applied electric field. Examples of the ferroelectric materials that may be used in the ferroelectric material layer 106 may include, but are not limited to, Barium Titanate (BaTiO₃), Hafnium Oxide (HfO₂), HfO₂ doped with Zirconium (HfZrO₂), Lithium Niobate (LiNbO₃), Bismuth Ferrite (BiFeO₃), Titanium Dioxide (TiO₂), Germanium Telluride (GeTe), Sodium Potassium Niobate (Na_{0.5}K_{0.5}NbO₃), Lead Zirconate Titanate (PZT) (various ratios of PbZrO₃ and PbTiO₃), Potassium Niobate (KNbO₃), Bismuth Titanate (Bi₄Ti₃O₁₂), Strontium Bismuth Tantalate (SrBi₂Ta₂O₉, SBT), Lead Lanthanum Zirconate Titanate (PLZT), Lead Zirconate Titanate (PZT), Lead Magnesium Niobate-Lead Titanate (PMN-PT), Tungsten Bronze Structures (e.g., Sr_{0.5}Ba_{0.5}Nb₂O₆), Polyvinylidene Fluoride (PVDF), Yttrium Manganite (YMnO₃), Tin Telluride (SnTe), Cadmium Telluride (CdTe), Rubidium Nitrate (RbNO₃), Sodium Nitrite (NaNO₂), Potassium Dihydrogen Phosphate (KH₂PO₄), Triglycine Sulfate (TGS), Gadolinium Molybdate (Gd₂(MoO₄)₃), Lead Scandium Tantalate (PST), Lead Indium Niobate (PIN), or combinations thereof. In some examples, the ferroelectric material layer 106 may comprise a single layer of a ferroelectric material which may include one or combinations of the ferroelectric materials listed hereinabove. In certain other examples, the ferroelectric material layer 106 may be a multi-layered structure comprising a dielectric layer disposed between two ferroelectric material layers enhancing the overall electro-optical effect (see FIG. 2, for example).

Under the application of the electric field, the ferroelectric materials exhibit spontaneous polarization. Such a change in the polarization of the ferroelectric material under the application of the electric field causes a change in the refractive index of the ferroelectric material layer 106 resulting in phase shifting of an optical signal propagating via the optical waveguide 104. In particular, the polarization that the ferroelectric material attains due to the applied electric field remains unchanged even after the electric field is removed. Accordingly, the phase shift induced in the optical signal may be non-volatile in nature (i.e., the proposed optical device can maintain the phase shift in the optical signal even after the electric field is removed).

Furthermore, the optical device 102 includes a transition material layer 108 disposed in electrical contact with the ferroelectric material layer 106 such that the ferroelectric material layer 106 and the transition material layer 108 are stacked vertically over the optical waveguide 104. In some examples, the transition material layer 108 and the ferroelectric material layer 106 may be designed to have the same width (e.g., a measure along the lateral direction 12) as that of the waveguide core 112. The transition material layer 108 may be made of a transparent conductive material. In some examples, the transition material layer 108 may include a thermally conductive oxide, a doped semiconductor material, or a combination thereof. Examples of transparent conductive materials may include but are not limited to, Indium Tin Oxide (ITO), Zinc Oxide (ZnO), Fluorine-doped Tin Oxide (FTO), Aluminum-doped Zinc Oxide (AZO), Antimony-doped Tin Oxide (ATO), Graphene, Silver Nanowires (AgNWs), Carbon Nanotubes (CNTs), Copper Nanowires (CuNWs), Poly(3,4-ethylenedioxythiophene) polystyrene sulfonate (PEDOT), Doped semiconductor, Doped silicon, Doped InP, Doped GaAS, Doped Cadmium Sulfide (CdS), Doped Tin Oxide (SnO₂), Doped Gallium Nitride (GaN), or combinations thereof.

The transition material layer 108 serves multiple purposes. For instance, the presence of the transition material layer 108 between the ferroelectric material layer 106 and the electrode 110A allows the electrode 110A to be disposed vertically away from the optical waveguide 104 and the ferroelectric material layer 106. In particular, the transition material layer 108 is made of predetermined thickness such that the electrode 110A is positioned vertically away from an optical mode 107, thereby creating separation between the bottom surface of the electrode 110A and the optical mode 107. Accordingly, the optical mode 107 may not reach the electrode 110A, thereby preventing the light absorption via the electrode 110A reducing optical losses. This way, the transition material layer 108 may function as a light absorption-blocking region. Further, as the transition material layer 108 is made of transparent conductive material(s), it provides good electrical conductivity with the electrode 110A. Furthermore, the positioning of the transition material layer 108 in electrical contact with the ferroelectric material layer 106 causes the application of the vertical electric field across the ferroelectric material layer 106.

Moreover, the optical device 102 may include electrodes, such as the first electrode 110A and the second electrode 110B (collectively referred to as electrodes 110A, 110B). As depicted in FIG. 1, the first electrode 110A and the second electrode 110B are respectively formed in electrical contact (e.g., in direct physical contact or via any intermediate electrically conductive material) with the transition material layer 108 and the waveguide arm 116. In particular, the electrode 110A may be formed on top of (i.e., vertically over) the transition material layer 108, whereas the electrode 110B may be formed on top of the waveguide arm 116. Examples of the materials used to form the electrodes 110A, 110B may include, but are not limited to, copper (Cu), gold (Au), Al, and/or platinum (Pt). Furthermore, in some examples, for enhanced conductivity, a region 118 (also referred to as a contact region 118) of the waveguide arm 116 that contacts the electrode 110B may have a higher concentration of respective doping in comparison to doping concentrations in the waveguide core 112. Accordingly, the region 118 may be considered a highly doped region and is marked with a label “p++” as depicted in FIG. 1.

During operation, an operating voltage is applied to the optical device 102 via the electrodes 110A and 110B to control the phase shift in the optical signal passing through the optical waveguide 104. As depicted in FIG. 1, the ferroelectric material layer 106 is vertically sandwiched between the transition material layer 108 and the optical waveguide 104, and the electrodes 110A and 110B are formed in electrical contact with the transition material layer 108 and the optical waveguide 104, respectively. Therefore, the application of the operating voltage (e.g., 5V) across the electrodes 110A and 110B may exert an electric field (represented via arrows, some of which are marked with a letter ‘E’) that is oriented in the vertical direction. The electrical field ‘E’ that is exerted in the vertical direction is referred to as a vertical electric field. This vertical electric field causes the polarization of cells in the ferroelectric material layer 106 altering the refractive index of the ferroelectric material layer 106. As the optical mode 107 overlaps with the ferroelectric material layer 106, the change in the refractive index of the ferroelectric material layer 106 induces a phase shift in the optical signal propagating via the optical waveguide 104. As it is understood, the polarization induced in the ferroelectric material layer 106 remains unchanged even after removing the applied voltage, and therefore the phase shift in the optical signal is also non-volatile. To reset the phase shift in the optical signal, in some examples, a reverse polarity voltage may be applied across the electrodes 110A and 110B. For example, if the phase shift was induced in the optical signal by applying a positive voltage across the electrodes 110A and 110B, a negative voltage may be applied across the electrodes 110A and 110B to reset the phase shift.

As will be appreciated, the optical device 102 having the hybrid photonic structure noted hereinabove allows for the application of the vertical electric field to the ferroelectric material layer 106. Further, due to the presence of the transition material layer 108, an electrode such as the electrode 110A may be positioned away from the ferroelectric material layer 106 and the optical waveguide 104 which keeps the optical mode 107 away from the electrode 110A. Therefore, such a placement of the transition material layer 108 between the electrode 110A and the ferroelectric material layer 106 enhances optical confinement and reduces optical losses.

Furthermore, in the device structure of the optical device 102, the transition material layer 108, the ferroelectric material layer 106, and the optical waveguide 104 are vertically stacked such that the ferroelectric material layer 106 is sandwiched between the transition material layer 108 and the optical waveguide 104. In particular, the increased surface contact of the entirety of the top and bottom surfaces of the ferroelectric material layer 106 respectively with the transition material layer 108 and the optical waveguide 104 allows the vertical electric field to be uniformly and strongly applied across the ferroelectric material layer 106. As a result, a much stronger electric field may be created with similar applied voltages compared to conventional optical devices that apply lateral electric field, while minimizing optical losses. Additionally, the vertical device structure of the proposed optical device 102 allows for the incorporation of multiple ferroelectric layers, enhancing the electro-optical effect. Moreover, electronic simulations performed for the proposed optical device indicate that the proposed optical device can significantly improve the performance of the non-volatile phase shifter, i.e., impart a greater amount of phase shift for a given unit voltage in comparison to the conventional optical phase shifters. Additionally, ferroelectric materials like hafnium zirconium oxide can be easily deposited using CMOS-compatible processes, making the proposed hybrid photonic structures highly suitable for large-scale CMOS-compatible manufacturing.

Referring to FIG. 2, a cross-sectional view 200 of an example optical device 202 is presented. The optical device 202 may be an example representative of the optical device 102. The cross-sectional view 200 of the optical device 202 in FIG. 2 depicts certain additional structural and configurational details about the optical device 102. For ease of illustration, identical parts are labeled with the same reference numerals as used in FIG. 1, the description of which is not repeated herein.

In some examples, the optical device 202 may be formed using a substrate 204. The substrate 204 may be a silicon-on-insulator (SOI) substrate. In some examples, the substrate 204 may include a base substrate layer 210, a base oxide layer 206, and a device layer 208. The base substrate layer 210 may be made of semiconductor material, for example, silicon (Si). Other examples of materials that may be used to form the base substrate layer 210 may include but are not limited to, Si, SiN, InP, GaAs, SiC, AlGaAs, InGaAs, SiO₂, Si₃N₄, LiNbO₃, GaN, Polymer, or combinations thereof.

Further, as depicted in FIG. 2, the substrate 204 may include a base oxide layer 206 formed over an underlying the base substrate layer 210. For example, the base oxide layer 206 may be formed by oxidizing the substrate 204. In the implementation of FIG. 2, for the base substrate layer 210 made of silicon, the base oxide layer 206 may comprise SiO₂, which may be formed in the presence of oxygen at a temperature ranging from, 900° C. to 1380° C., for example. In some examples, the base oxide layer 206 may be a buried oxide (BOX) layer (e.g., the SiO₂ may be buried in the base substrate layer 210). In some examples, a layer of SiO₂ may be buried in the base substrate layer 210 at a depth ranging from less than 100 nm to several micrometers from the wafer surface depending on the application. Other examples of the base oxide layer 206 may include but are not limited to, Si₃N₄, Al₂O₃, HfO₂, diamond, SiC, or combinations thereof.

The device layer 208 is disposed on top of the base oxide layer 206. In the example implementation of FIG. 2, the device layer 208 is composed of silicon. In some other examples, the device layer may be made of silicon nitrides (e.g., Si₃N₄), InP, GaAs, SiC, AlGaAs, InGaAs, SiO₂, LiNbO₃, GaN, Polymer, or combinations thereof. The device layer 208 may be suitably shaped (e.g., via techniques such as photolithography and etching) to form one or more regions, such as the optical waveguide 104. Further, the contact region 118 shown as a highly doped region may provide enhanced electrical conductivity between the optical waveguide 104 and the electrode 110B. In some examples, the contact region 118 may be formed using a material different from the material of the optical waveguide 104. For example, the contact region 118 may also be formed using materials, such as but not limited to, InP, GaAs, AlGaAs, or combinations thereof, which may be suitably doped (e.g., highly doped) to provide electrical conductivity between the optical waveguide 104 and the electrode 110B.

Furthermore, in some examples, the ferroelectric material layer 106 may comprise a single layer of ferroelectric material (e.g., comprising one or combinations of the materials listed hereinabove). In certain other examples, to further enhance the electro-optical effect, the ferroelectric material layer 106 may be designed to have a multi-layered structure comprising a dielectric layer disposed between two ferroelectric material layers. Examples of the dielectric materials that may be disposed between two layers of the ferroelectric material layers may include but are not limited to, Aluminum oxide (Al₂O₃), Silicon dioxide (SiO₂), Silicon nitride (Si₃N₄), Titanium dioxide (TiO₂), Hafnium oxide (HfO₂), polyimide, benzocyclobutene (BCB), or combinations thereof. By way of example, as depicted in an enlarged view 209 of a portion 211 of the optical device 202, the ferroelectric material layer 106 may include multiple layers (e.g., three layers) of Hf_{0.5}Zr_{0.5}O₂ interleaved with Al₂O₃ in the ferroelectric material layer 106. In some other examples, the multi-layered structure may include interleaved ferroelectric material layers. For example, the ferroelectric material layer 106 may be formed by alternatingly forming layers of two or more ferroelectric materials noted hereinabove.

In addition, in some examples, before the metal electrodes are formed, the device structure of the optical device 202 may be encapsulated by depositing or forming an insulation material 219 different from the material of the optical waveguide 104. Examples of the insulating material 219 may include but are not limited to, Al₂O₃, SiO₂, Si₃N₄, TiO₂, HfO₂, BCB, or combinations thereof.

Moreover, in some examples, an external power source, such as a power source 212 (shown using a dotted outline as it is not part of the optical device 202) may be connected to the optical device 202 via the electrodes 110A, 110B. The power source 212 may be representative of any energy source (e.g., a battery, or a regulated power supply) or any circuit that can apply a potential difference (i.e., voltage) across the electrodes 110A, 110B. The voltage applied across the electrodes 110A, 110B is referred to as an operating voltage. The operating voltage may be applied to control the phase shift in the optical signal passing through the optical waveguide 104. In particular, in one example, the voltage applied across the electrodes 110A and 110B may exert a vertical electrical field across the ferroelectric material layer 106. This electric field causes the polarization of cells in the ferroelectric material layer 106 altering the refractive index of the ferroelectric material layer 106. As an optical mode 207 overlaps with the ferroelectric material layer 106, the refractive index of the ferroelectric material layer 106 induces a phase shift in the optical signal propagating via the optical waveguide 104. As it is understood, the polarization induced in the ferroelectric material layer 106 remains unchanged even after removing the applied voltage, and therefore the phase shift in the optical signal is also non-volatile.

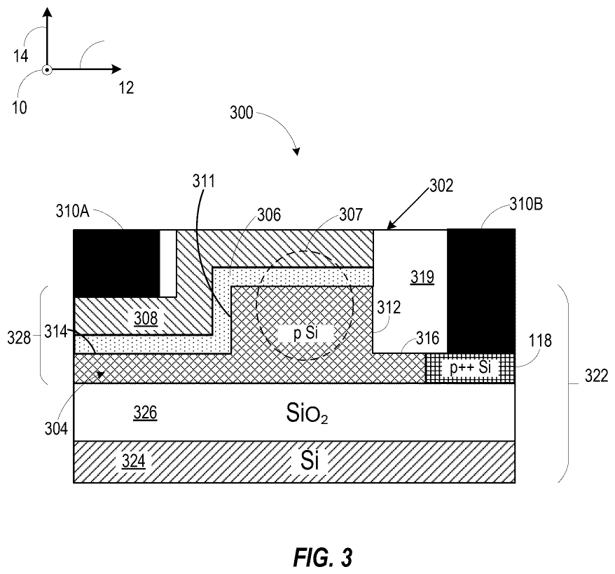

In some examples, to ease additional fabrication steps, to reduce the overall height of the optical device, and/or to minimize optical coupling with the electrodes, the transition material layer, the electrodes, and the ferroelectric material layer may be differently arranged and yet achieve the non-volatile phase-shift and high vertical electric field across the ferroelectric material layer. Various such example optical device configurations are described in conjunction with FIGS. 3-6.

In FIG. 3, a cross-sectional view 300 of another example optical device 302 is presented. The optical device 302 of FIG. 3 may be an alternative example of an optical device, and includes several structural layers and aspects similar to those described in FIG. 2, details of which are not repeated herein. For example, the optical device 302 may be formed using a substrate 322. The optical device may include an optical waveguide 304, a ferroelectric material layer 306, a transition material layer 308, electrodes 310A, 310B, and an insulation material 319 that correspond to the optical waveguide 104, the ferroelectric material layer 106, the transition material layer 108, the electrodes 110A and 110B, and insulation material 219, respectively, described in FIGS. 1-2. The optical waveguide 304 includes a waveguide core 312 and waveguide arms 314, 316 similar to the respective elements described in FIG. 2. The substrate 322 may include a base substrate layer 324, a base oxide layer 326, and device layer 328 similar to the respective elements described in FIG. 2.

In particular, the optical device 302 represents an example configuration wherein the electrode 310A may be formed away from an optical mode 307. For example, the ferroelectric material layer 306 may be extended over the waveguide arm 314. This way, the ferroelectric material layer 306 is designed to contact the top surface of the waveguide core 312, a sidewall 311 of the waveguide core 312 between the top surface of the waveguide core 312 and the waveguide arm 314, and the waveguide arm 314, thereby forming a step-shaped ferroelectric material layer 306. Further, the transition material layer 308 may also be formed, fully or partially, over the ferroelectric material layer 306. In particular, in one example, the transition material layer 308 may be formed in direct physical contact with the entire top surface of the ferroelectric material layer 306. Accordingly, the transition material layer 308 may be formed to have a step-shaped profile similar to that of the ferroelectric material layer 306.

While the electrode 310B may be formed at a similar location as the electrode 110B depicted in FIGS. 1 and 2, the other electrode 310A may be formed in contact with the transition material layer 308 to the left side of the waveguide core 312. In particular, the electrode 310A may be formed laterally away from the sidewall 311 of the waveguide core 312. In particular, the electrode 310A may be formed by etching away a portion of the insulation material 319 until the transition material layer 308 is exposed and then filling the resulting space using an electrically conductive material (e.g., metal).

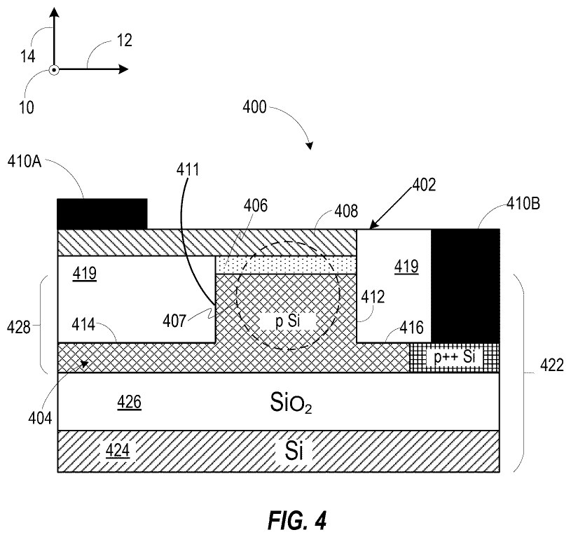

Referring to FIG. 4, FIG. 4 depicts a cross-sectional view 400 of another example optical device 402 having a slightly modified configuration compared to the optical device 302 of FIG. 3 within the purview of the present disclosure.

The optical device 402 of FIG. 4 may be another alternative example of an optical device that includes several structural layers and aspects similar to those described earlier, details of which are not repeated herein. For example, the optical device 402 may be formed using a substrate 422. In particular, the optical device 402 includes an optical waveguide 404, a ferroelectric material layer 406, a transition material layer 408, electrodes 410A and 410B, and an insulation material 419 that correspond to the optical waveguide 104, the ferroelectric material layer 106, the transition material layer 108, the electrodes 110A and 110B, and the insulation material 219, respectively, described in FIGS. 1-2. Further, the optical waveguide 404 includes a waveguide core 412 and waveguide arms 414, 416 similar to the respective elements described in FIG. 2. The substrate 422 may include a base substrate layer 424, a base oxide layer 426, and device layer 428 similar to the respective elements described in FIGS. 2, 3.

In particular, for most of the part, the optical device 402 may have a similar configuration as that of the optical device 302 of FIG. 3, except that the transition material layer 408 in FIG. 4 extends straight over the ferroelectric material layer 406 thereby not forming a step-shaped profile. In particular, the transition material layer 408 may extend laterally from the rightmost end of the ferroelectric material layer 406 to the leftmost end of the optical device in a straight-line manner as depicted in FIG. 3. Further, the electrode 410A is formed over the transition material layer 408 to the left side of the sidewall 411 the waveguide core 412. In particular, the electrode 410A is formed laterally away from the sidewall 411 of the waveguide core 412.

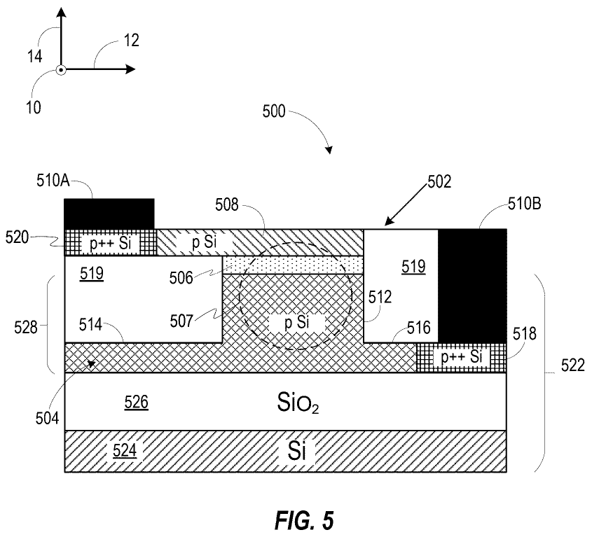

Turning to FIG. 5, a cross-sectional view 500 of an optical device 502 having yet another configuration is presented. In particular, the optical device 502 of FIG. 5 includes several structural layers and aspects similar to those described in earlier drawings, in particular, FIG. 4, details of which are not repeated herein. The optical device 502 of FIG. 5 includes several structural layers and aspects similar to those described earlier, details of which are not repeated herein. For example, the optical device 502 may be formed using a substrate 522. The optical device 502 may include an optical waveguide 504, a ferroelectric material layer 506, a transition material layer 508, electrodes 510A and 510B, and insulation material 519 that correspond to the optical waveguide 404, the ferroelectric material layer 406, the transition material layer 408, the electrodes 410A and 410B, and the insulation material 419 respectively, described in FIG. 4. The optical waveguide 504 includes a waveguide core 512 and waveguide arms 514, 516 similar to the respective elements described in FIG. 2. The substrate 522 may include a base substrate layer 524, a base oxide layer 526, and device layer 528 similar to the respective elements described in FIG. 4.

In general, the optical device 502 may have a structural configuration similar to the optical device 402 of FIG. 4, except that the transition material layer 508 of FIG. 5 is formed using a doped semiconductor material. In one example, the transition material layer 508 may be formed to have the same material properties as that of the optical waveguide 504. For example, the transition material layer 508 may be made of the same semiconductor material as that of the optical waveguide 504 and may include a similar type of doping. In some other examples, transition material layer 508 may be made of a different semiconductor material than the optical waveguide 504, but have a similar type of doping as the optical waveguide 504. For example, the optical waveguide 504 may be made of silicon with p-type doping, and the transition material layer 508 may be made of a III-V semiconductor material with p-type doping. Further, to provide enhanced electrical conductivity with the respective electrodes the waveguide arm 516 and the transition material layer 508 may include highly doped contact regions 518 and 520, respectively.

In certain examples, an optical waveguide in an example optical devices may also be formed using one or more insulating materials (e.g., dielectric materials). FIG. 6 depicts one such example optical device 600. The optical device 602 of FIG. 6 may be an alternative example of an optical device and includes several structural layers and aspects similar to those described earlier in conjunction with FIG. 3, details of which are not repeated herein. For example, the optical device 602 may be formed using a substrate 622. In particular, the optical device 602 includes an optical waveguide 604, a ferroelectric material layer 606, a transition material layer 608, electrodes 610A and 610B, and an insulation material 619 that correspond to the optical waveguide 304, the ferroelectric material layer 306, the transition material layer 308, the electrodes 310A and 310B, and the insulation material 319, respectively, described in FIG. 3. The substrate 622 may include a base substrate layer 624, a base oxide layer 626, and device layer 628 similar to the respective elements described in earlier drawings.

The optical device 602 may have a structural configuration similar to the optical device 302 of FIG. 3 except for the following structural and material variations. In particular, the optical waveguide 604 does not include waveguide arms (such as the waveguide arms 314 and 316). Further, the optical waveguide 604 is made of an electrically conductive or non-conductive waveguide material, such as SiN. The silicon nitride used in the optical waveguide may be of any silicon nitride configuration, for example, Si₃N₄. In some other examples, the optical waveguide 604 may be made of any of the materials listed in conjunction with the optical waveguide 104 of FIG. 1. Furthermore, since the optical waveguide material (e.g., SiN) used in FIG. 6 is not conductive, the optical device 602 is designed to include an additional transition material layer, hereinafter referred to as, an intermediate transition material layer 609 to provide electrical conductivity between the optical waveguide 604 and the electrode 610B. The intermediate transition material layer 609 may be formed using any of the materials listed in conjunction with the transition material layer 108 in FIG. 1, for example. In particular, the intermediate transition material layer 609 of a step-shape may be formed such that a portion of the intermediate transition material layer 609 may be sandwiched between and in electrical contact with the top surface of the optical waveguide 604 and the bottom surface of the ferroelectric material layer 606. Further, the rest of the intermediate transition material layer 609 is formed in electrical contact with a right-hand side wall of the optical waveguide 604 and the electrode 610B.

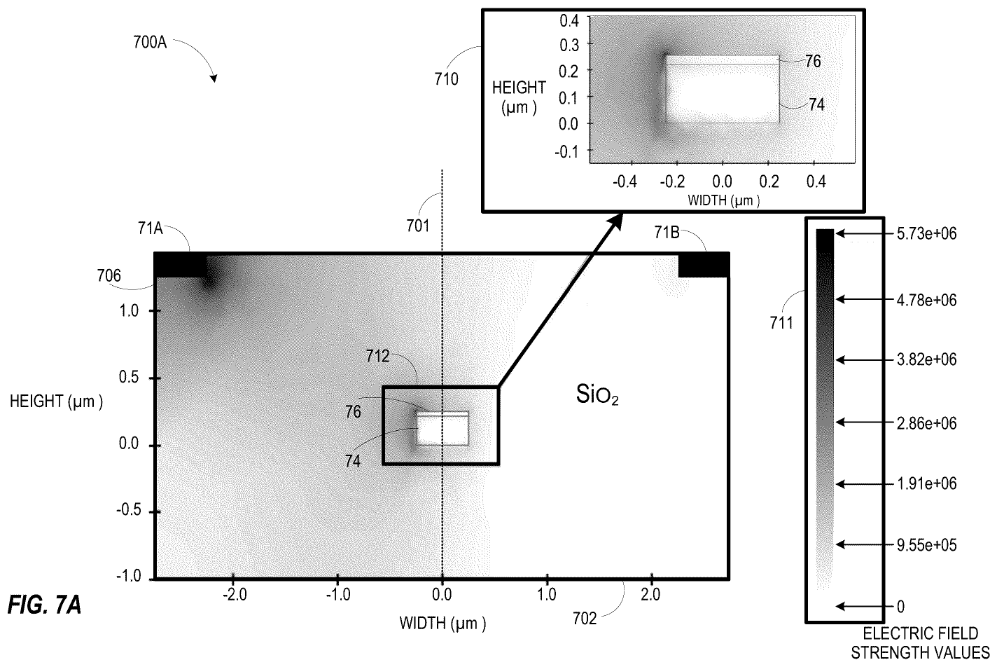

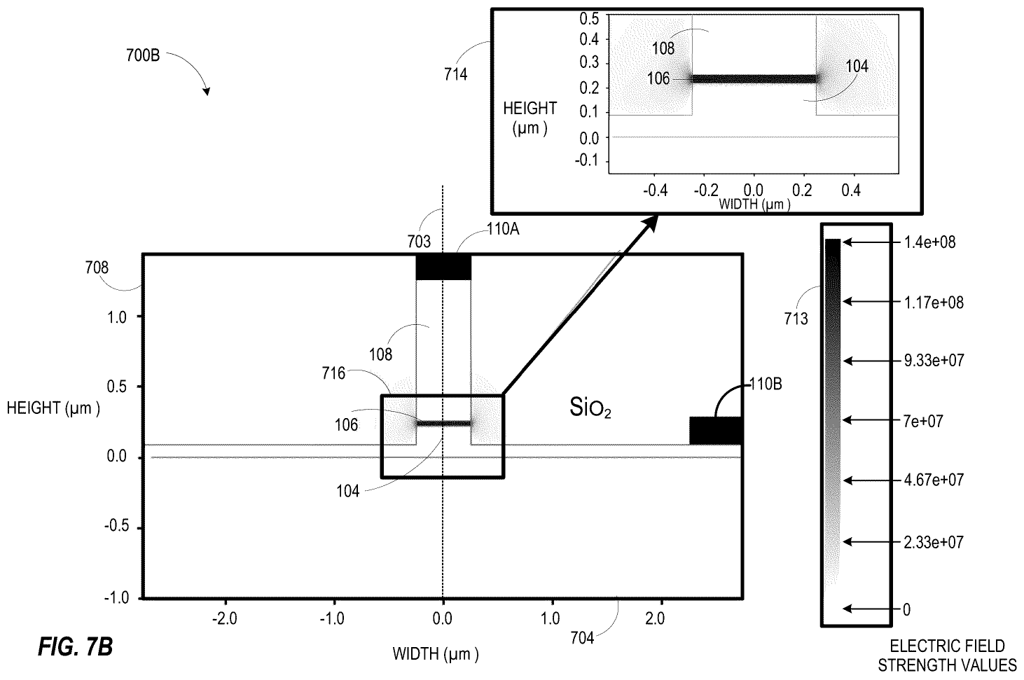

A comparison of the electric fields of a conventional optical device applying a lateral electric field and an example optical device of the present disclosure that applies a vertical electric field is described with the help of the graphical representations of FIGS. 7A and 7B. For ease of illustration and comparison, FIGS. 7A and 7B are hereinafter concurrently described. In particular, FIG. 7A depicts a graphical representation 700A showing a first simulated electric field distribution for a conventional optical device that applies a lateral electric field. Further, FIG. 7B represents a second graphical representation 700B that depicts a second simulated electric field distribution for an example optical device, such as the optical device 202 of FIG. 1 that applies a vertical electric field.

It may be noted that, in the graphical representations 700A and 700B, not all of the parts/material layers may be visible, and the respective optical device may include additional components or material layers. In the graphical representations 700A and 700B, X-axes 702 and 704 represent a width in μm with reference to imaginary center lines 701 and 703 (represented via dotted lines) that divide the device structures of the respective optical devices into two equal parts in the lateral direction. In particular, a value of zero (0) on the X-axes 702 and 704 represents a mid-point of the width of the respective optical devices. Further, the Y-axes 706 and 708 represent structure heights in μm, wherein zero (μm) indicates the bottom of the device layers (e.g., the bottom of the respective optical waveguides). Electric field distribution scales 711 and 713 represent values of electric field strength over a color scale. The graphical representations of FIGS. 7A and 7B are obtained using simulations performed using a photonic simulation software.

For the simulation presented in FIG. 7A of the conventional optical device exerting the lateral electric field, the width, and the height of a rectangular Silicon optical waveguide 74 are respectively set to 500 nm and 220 nm. Further, the conventional optical device is designed to have a non-volatile optical phase change material 76 (e.g., a ferroelectric material) on top of the Si waveguide. The width of the non-volatile optical phase change material is set to 500 nm (i.e., same as the width of the Si waveguide). Further, the non-volatile optical phase change material is designed to consist of three layers of HfO₂ interleaved with four layers of Al₂O₃ (not shown in FIG. 7, but may be similar to one described in the enlarged view 209 shown in FIG. 2), wherein the thickness of each HfO₂ layer is set to 10 nm and the thickness of each Al₂O₃ layer is set to 1 nm, and which are arranged in the following order (starting from top to bottom)—Al₂O₃/HfO₂/Al₂O₃/HfO₂/Al₂O₃/HfO₂/Al₂O₃, resulting in the total height of the non-volatile optical phase change material as 34 nm. Further, the rectangular Silicon optical waveguide is encapsulated with SiO₂, and two metal electrodes 71A and 71B are positioned 1μm above the rectangular Silicon optical waveguide vertically and 2 μm laterally away from the waveguide edges. In this lateral conventional optical device configuration, the left-hand side electrode 71A is set to 5 V, and the right-hand side electrode 71B is set to 0 V (e.g., a potential difference of 5 volts between the two electrodes 71A and 71B), as marked in FIG. 7A.

Further, for the simulation presented in FIG. 7B of the example optical device 202 of FIG. 2, the optical waveguide 104 may be a Silicon rib waveguide having a thickness of 220 nm and a width of 500 nm. Further, the height of the device layer 208 may be set to 90 nm. Furthermore, the ferroelectric material layer 106 may be made of the non-volatile optical phase change materials as described in conjunction with FIG. 7A. For example, the ferroelectric material layer 106 comprising three layers of HfO₂ interleaved with four layers of Al₂O₃, in the following order (starting from top to bottom)—Al₂O₃/HfO₂/Al₂O₃/HfO₂/Al₂O₃/HfO₂/Al₂O₃ may be disposed directly on the top of the optical waveguide core 112. In particular, the thickness of each HfO₂ layer is set to 10 nm and the thickness of each Al₂O₃ layer is set to 1 nm. Further, the transition material layer 108 may be made of indium-tin-oxide (ITO) and has a thickness of 1 μm above the ferroelectric material layer 206. The electrode 110B is placed on top of the transition material layer 108, and the other electrode 110B is formed 2 μm laterally away from a side of the waveguide core 212. An operating voltage of +5 volts may be applied across the electrodes 110A and 110B (e.g., by applying +5 v to the electrode 110A and 0 v to the electrode 110B).

The electric field distributions 700A and 700B may be obtained based on simulations performed using “Lumerical CHARGE solver” (e.g., an example photonic simulation software) for the experimental set-up described hereinabove. In particular, as depicted in a zoomed-in plot region 710 of a portion 712 of the graphical representation 700A, the electric field in the conventional optical device is mainly concentrated near the left-hand side electrode and the top-left corner of the non-volatile phase change material. However, the electric field in most of the non-volatile phase change material is much lower in comparison to the electric field near the left-hand side electrode 71A and the top-left corner of the non-volatile phase change material. In contrast, as seen in a zoomed-in plot region 714 of a portion 716 of the graphical representation 700B for the example optical device 202, the electric field is mainly concentrated within the transition material layer 108, and the electric field strength is significantly higher compared to the electric field seen in the zoomed-in plot region 710 for the most portion of the non-volatile phase change material. This indicates that for the same magnitude of the applied voltage (e.g., 5V) across the respective electrodes, the proposed optical device exerts a significantly higher electric field in comparison to the conventional optical device. Such a higher electric field allows the proposed optical device to cause greater phase shift in comparison to the conventional optical device.

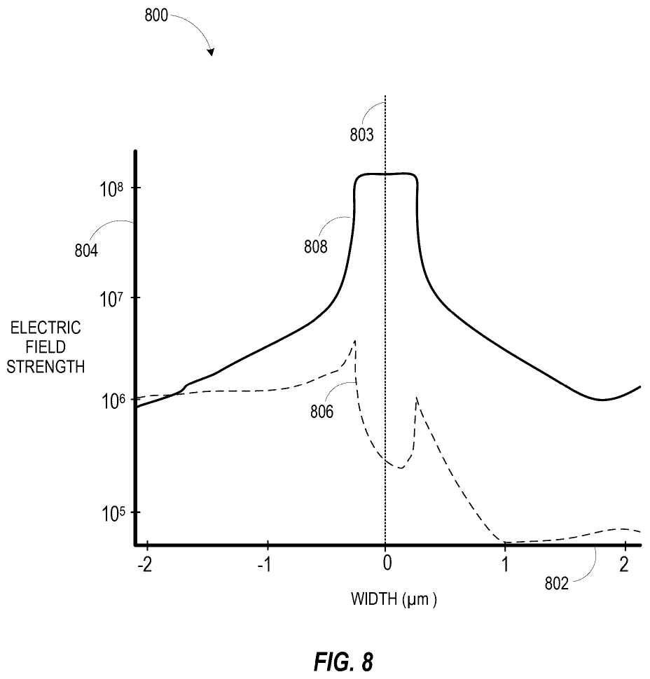

Further, FIG. 8 depicts a graphical representation 800 comparing the electric field distributions of a conventional optical device specified in FIG. 7A and the example optical device 202 with the specifications listed in FIG. 7B. In the graphical representation 800, the X-axis 802 represents a width in μm with reference to an imaginary center line 803 (represented via a dotted line) that divides the device structures of the respective optical devices into two equal parts. In particular, a value of zero (0) on the X-axis 802 represents a mid-point of the width of the respective optical devices. Further, the Y-axis 804 represents electric field strength. The reference numerals 806 and 808 respectively represent plots of electric field strengths for the conventional device having the specifications listed in conjunction with FIG. 7A and the example optical device 202 with the specifications listed in conjunction with FIG. 7B. As depicted in FIG. 8, the top flat section of the electric field strength plot 808 near the center (e.g., zero value on the X-axis 802) shows that the proposed example optical device 202 exerts a much stronger vertical electric field across the ferroelectric material layer compared to the lateral electric field exerted by the conventional optical device. The comparison of the maximum values of the simulated electric field strengths depicted in plots 806 (represented via a dashed line) and 808 (represented via a solid line) demonstrates that the electric field exerted in the proposed example optical device is more than 35 times greater relative to the electric field strength in the conventional optical device.

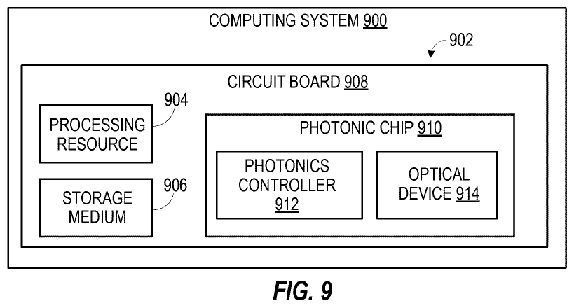

Referring to FIG. 9, a block diagram of an example computing system 900 is presented. Examples of the computing system 900 may include but are not limited to, computers (stationary or portable), servers, storage systems, wireless access points, network switches, routers, docking stations, printers, or scanners. The computing system 900 may be offered as a stand-alone product, or a packaged solution, and can be utilized on a one-time full product/solution purchase or pay-per-use basis. The computing system 900 may include one or more multi-chip modules, for example, a multi-chip module (MCM) 902 to process and/or store data. In some examples, the MCM 902 may include a processing resource 904 and a storage medium 906 mounted on a circuit board 908. Also, in some examples, the MCM 902 may host a photonic chip 910 on the circuit board 908. In some other examples, one or more of the processing resource 904, the storage medium 906, and the photonic chip 910 may be hosted on different MCMs (not shown). The circuit board 908 may be a printed circuit board (PCB) that includes several electrically conductive traces (not shown) to interconnect the processing resource 904, the storage medium 906, and the photonic chip 910 with each other and/or with other components disposed on or outside of the PCB.

The processing resource 904 may be a physical device, for example, one or more central processing units (CPUs), one or more semiconductor-based microprocessors, microcontrollers, one or more graphics processing units (GPUs), application-specific integrated circuits (ASICs), a field-programmable gate array (FPGA), other hardware devices, or combinations thereof, capable of retrieving and executing the instructions stored in the storage medium 906. The processing resource 904 may fetch, decode, and execute the instructions stored in the storage medium 906. As an alternative or in addition to executing the instructions, the processing resource 904 may include at least one integrated circuit (IC), control logic, electronic circuits, or combinations thereof that include several electronic components. The storage medium 906 may be any electronic, magnetic, optical, or any other physical storage device. The storage medium 906 may store instructions that are readable and executable by the processing resource 904. Thus, the storage medium 906 may be, for example, Random Access Memory (RAM), non-volatile RAM (NVRAM), an Electrically Erasable Programmable Read-Only Memory (EEPROM), a storage device, an optical disc, and the like. In some embodiments, the storage medium 906 may be a non-transitory storage medium, which does not encompass transitory propagating signals.

Further, in some examples, the photonic chip 910 may include a photonics controller 912 and one or more photonic devices such as the optical device 914. The optical device 914 may be an example representative of any of the optical devices 102, 202, 302, 402, 502, or 602 described in conjunction with FIGS. 1-6. For illustration purposes, in FIG. 9, the photonic chip 910 is shown to include a single optical device 914. The use of a different number of optical devices or the use of several different types of optical devices in the photonic chip 910 is also envisioned within the scope of the present disclosure. For example, the photonic chip 910 may also include other photonic devices such as but not limited to, optical converters, optical cables, waveguides, optical modulators (e.g., ring modulator), optical demodulators (e.g., ring demodulator), resonators, light sources (e.g., lasers), or combinations thereof. The photonic chip 910 may function as an optical receiver, optical transmitter, optical transceiver, optical communication and/or processing medium for the data and control signals (e.g., control voltages) received from the photonics controller 912. In some example implementations, the photonics controller 912 may be implemented using an IC chip such as, but not limited to, an ASIC, an FPGA chip, a processor chip (e.g., CPU and/or GPU), a microcontroller, or a special-purpose processor. During the operation of the computing system 900, the photonics controller 912 may apply an operating voltage to the optical device 914 to control phase shifts applied to the optical signal passing through the optical device 914.

The terminology used herein is for the purpose of describing particular examples and is not intended to be limiting. As used herein, the singular forms “a,” “an,” and “the” are intended to include the plural forms as well, unless the context clearly indicates otherwise. The term “another,” as used herein, is defined as at least a second or more. The term “coupled to” as used herein, is defined as connected, whether directly without any intervening elements or indirectly with at least one intervening element, unless indicated otherwise. For example, two elements may be coupled to each other mechanically, electrically, optically, or communicatively linked through a communication channel, pathway, network, or system. Further, the term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

While certain implementations have been shown and described above, various changes in form and details may be made. For example, some features and/or functions that have been described in relation to one implementation and/or process may be related to other implementations. In other words, processes, features, components, and/or properties described in relation to one implementation may be useful in other implementations. Furthermore, it should be appreciated that the systems and methods described herein may include various combinations and/or sub-combinations of the components and/or features of the different implementations described. Moreover, method blocks described in various methods may be performed in series, parallel, or a combination thereof. Further, the method blocks may as well be performed in a different order than depicted in flow diagrams.

Further, in the foregoing description, numerous details are set forth to provide an understanding of the subject matter disclosed herein. However, an implementation may be practiced without some or all of these details. Other implementations may include modifications, combinations, and variations from the details discussed above. It is intended that the following claims cover such modifications and variations.

What is claimed is:

1. An optical device comprising:
an optical waveguide;
a ferroelectric material layer formed over the optical waveguide;
a transition material layer comprising a transparent conductive material disposed in electrical contact with the ferroelectric material layer such that the ferroelectric material layer and the transition material layer are stacked vertically over the optical waveguide; and
a pair of electrodes comprising a first electrode in electrical contact with the transition material layer and a second electrode in electrical contact with the optical waveguide,
wherein an application of an operating voltage across the pair of electrodes causes a vertical electric field across the ferroelectric material layer.

2. The optical device of claim 1, wherein the ferroelectric material layer comprises one or more of BaTiO₃, Hf_{0.5}Zr_{0.5}O₂, or HfO₂.

3. The optical device of claim 1, wherein the ferroelectric material layer is a multi-layered structure comprising a dielectric layer disposed between two ferroelectric material layers.

4. The optical device of claim 1, wherein the first electrode is formed vertically over the optical waveguide.

5. The optical device of claim 1, wherein the first electrode is formed laterally away from the optical waveguide.

6. The optical device of claim 1, wherein the transparent conductive material comprises a thermally conductive oxide, a doped semiconductor material, or a combination thereof.

7. The optical device of claim 6, wherein the doped semiconductor material and the optical waveguide comprise the same doping type.

8. The optical device of claim 1, wherein the transition material layer has a predetermined thickness to create separation between the first electrode and an optical mode of optical signal propagating via the optical waveguide thereby reducing optical losses.

9. The optical device of claim 1, wherein the ferroelectric material layer is formed on top of the optical waveguide and in direct physical contact with the optical waveguide.

10. The optical device of claim 1, further comprising an intermediate transition material layer disposed between the optical waveguide and the ferroelectric material layer, wherein the intermediate transition material layer comprises a transparent conductive material.

11. The optical device of claim 1, wherein the optical waveguide is made of Silicon Nitride (SiN).

12. An optical phase-shifter comprising:
a silicon waveguide;
a ferroelectric material layer formed over the silicon waveguide;
a transition material layer comprising a transparent conductive material disposed in electrical contact with the ferroelectric material layer such that the ferroelectric material layer and the transition material layer are stacked vertically over the silicon waveguide; and
a pair of electrodes comprising a first electrode formed on top of the transition material layer and in electrical contact with the transition material layer and a second electrode in electrical contact with the silicon waveguide,
wherein an application of an operating voltage across the pair of electrodes causes a vertical electric field across the ferroelectric material layer resulting in a non-volatile phase-shift in an optical signal propagating via the silicon waveguide.

13. The optical phase-shifter of claim 12, wherein the ferroelectric material layer is a multi-layered structure comprising a dielectric layer disposed between two ferroelectric material layers.

14. The optical phase-shifter of claim 12, wherein the transparent conductive material comprises a thermally conductive oxide, a doped semiconductor material, or a combination thereof.

15. The optical phase-shifter of claim 12, wherein the transition material layer has a predetermined thickness so as to dispose the first electrode vertically away from an optical mode of the optical signal thereby reducing optical losses.

16. The optical phase-shifter of claim 12, wherein the ferroelectric material layer formed on top of the silicon waveguide and in direct physical contact with the silicon waveguide.

17. A computing system comprising:
a circuit board; and
a photonic integrated circuit mounted on the circuit board, wherein the photonic integrated circuit comprises an optical device, wherein the optical device comprises:
an optical waveguide;
a ferroelectric material layer formed over the optical waveguide;
a transition material layer comprising a transparent conductive material disposed in electrical contact with the ferroelectric material layer such that the ferroelectric material layer and the transition material layer are stacked vertically over the optical waveguide; and
a pair of electrodes comprising a first electrode in electrical contact with the transition material layer and a second electrode in electrical contact with the optical waveguide,
wherein an application of an operating voltage across the pair of electrodes causes a vertical electric field across the ferroelectric material layer.

18. The computing system of claim 17, wherein the first electrode is formed vertically over the optical waveguide.

19. The computing system of claim 17, wherein the first electrode is formed laterally away from the optical waveguide.

20. The computing system of claim 17, wherein the optical waveguide is made of Silicon Nitride (SiN), and wherein the optical device further comprises an intermediate transition material layer disposed between the optical waveguide and the ferroelectric material layer, wherein the intermediate transition material layer comprises a transparent conductive material.
